(19) United States
(12) Patent Application Publication
(10) Pub. No.: US 2023/0008373 A1
(43) Pub. Date: Jan. 12, 2023

(54) METHOD FOR DETECTING GRANULAR MATTERS AND OPTICAL SORTER USED THEREFOR

(71) Applicant: SATAKE CORPORATION, Chiyoda-ku, Tokyo (JP)

(72) Inventors: Kohei HITA, Chiyoda-ku, Tokyo (JP); Atsushi TAKAYAMA, Chiyoda-ku, Tokyo (JP)

(73) Assignee: SATAKE CORPORATION, Chiyoda-ku, Tokyo (JP)

(21) Appl. No.: 17/785,201

(22) PCT Filed: Oct. 15, 2020
(86) PCT No.: PCT/JP2020/038908

§ 371 Date: Jun. 14, 2022

(30) Foreign Application Priority Data
Dec. 18, 2019 (JP) 2019-228610

(51) Int. Cl. G01N 21/85; B07C 5/342

(52) U.S. Cl. CPC G01N 21/85; B07C 5/342

(57) ABSTRACT

Provided is a method for detecting objects to be sorted with an optical sorter that can detect lateral portions of objects to be sorted with a flat shape.

A chute is provided with a plurality of parallel longitudinal grooves formed in the longitudinal direction by a plurality of elongated protruding walls, and objects to be sorted with a flat shape are allowed to flow downward on the surface of the chute such that substantially flat faces of the objects to be sorted touch the elongated protruding walls in the longitudinal grooves, and lateral portions of the objects to be sorted face the front-rear direction of the chute so that the optical detection unit detects the lateral portions of the objects to be sorted at the detection position. Preferably, the objects to be sorted with the flat shape are rice grains, and the optical detection unit detects bran remaining on back strings of the rice grains at the detection position.

### TECHNICAL FIELD

The present invention relates to an optical sorter for sorting granular matters, such as kernels or resin pellets, based on color, for example, and also relates to a method for detecting granular matters with an optical sorter that can detect lateral portions of granular matters with a flat shape, and an optical sorter used for such a method.

### BACKGROUND ART

Conventionally, there is known an optical sorter that sorts raw material including kernels, such as rice or wheat, resin pellets, coffee beans, or other granular matters, into non-defective ones and defective ones based on color, for example, or removes foreign matter mixed in the raw material based on color, for example (see Patent Literatures 1 and 2).

The optical sorter described in each of Patent Literatures 1 and 2 includes a chute that is arranged in an inclined manner and thus allows granular matters to flow downward, and an optical sorting unit that detects granular matters falling from the lower end of the chute and sorts the granular matters into non-defective granular matters and defective granular matters based on the results of detection.

The optical sorting unit includes a pair of optical detection devices disposed on the front side and the rear side of the fall-down path of granular matters falling from the lower end of the chute. After granular matters have flowed continuously downward by gravity while spreading in the width direction on the surface of the chute, the optical detection devices detect the granular matters that fall freely along a predetermined path from the lower end of the chute, from the front side and the rear side of the fall-down path.

By the way, when the granular matters are rice grains, in particular, long-grain rice, there may be cases where bran on back strings on the back portions of the rice grains cannot be completely removed through rice polishing and thus remains.

However, rice grains have a flat shape and thus flow downward on the surface of the chute in the optical sorter such that their opposite lateral faces, which are relatively flat, face the front-rear direction of the chute. Therefore, there is a problem in that the optical detection devices detect only the opposite lateral faces of the rice grains, and thus cannot detect bran remaining on the back strings of the rice grains.

### CITATION LIST

### Patent Literature

Patent Literature 1: Japanese Patent Laid-Open No. 2009-50760

Patent Literature 2: Japanese Patent Laid-Open No. 2011-92814

### SUMMARY OF INVENTION

### Technical Problem

In view of the foregoing, it is an object of the present invention to provide a method for detecting objects to be sorted with an optical sorter that can detect lateral portions of objects to be sorted with a flat shape, and an optical sorter used for such a method.

### Solution to Problem

To achieve the aforementioned object, an embodiment of the present invention is a method for detecting objects to be sorted with an optical sorter that detects lateral portions of objects to be sorted with a flat shape, the optical sorter including a chute with a predetermined width arranged in a manner inclined in the front-rear direction to allow the objects to be sorted to flow downward, an optical detection unit that detects the objects to be sorted at a detection position extending linearly, and an ejector unit that sorts and removes the objects to be sorted based on the result of detection of the optical detection unit, in which the chute is provided with a plurality of parallel longitudinal grooves formed in the longitudinal direction by a plurality of elongated protruding walls, and the objects to be sorted with the flat shape are allowed to flow downward on the surface of the chute such that substantially flat faces of the objects to be sorted touch the elongated protruding walls in the longitudinal grooves, and lateral portions of the objects to be sorted face the front-rear direction of the chute so that the optical detection unit detects the lateral portions of the objects to be sorted at the detection position.

In an embodiment of the present invention, the objects to be sorted with the flat shape are rice grains, and the optical detection unit preferably detects bran remaining on back strings of the rice grains at the detection position.

In addition, to achieve the aforementioned object, an embodiment of the present invention is an optical sorter including a chute with a predetermined width arranged in a manner inclined in the front-rear direction to allow objects to be sorted to flow downward; an optical detection unit that detects the objects to be sorted at a detection position extending linearly; and an ejector unit that sorts and removes the objects to be sorted based on the result of detection of the optical detection unit, in which the chute is provided with a plurality of parallel longitudinal grooves formed in the longitudinal direction by a plurality of elongated protruding walls, and when objects to be sorted with a flat shape flow downward on the surface of the chute, the objects to be sorted are allowed to flow downward on the surface of the chute such that substantially flat faces of the objects to be sorted touch the elongated protruding walls in the longitudinal grooves, and lateral portions of the objects to be sorted face the front-rear direction of the chute so that the optical detection unit can detect the lateral portions of the objects to be sorted at the detection position.

In an embodiment of the present invention, the chute is preferably inclined at predetermined angle (5 to 50 degrees, or preferably, 35 degrees) with respect to the vertical direction on the inclined plane arranged in an inclined manner in the front-rear direction.

In an embodiment of the present invention, the cross-section of each longitudinal groove provided in the chute along a direction orthogonal to the longitudinal direction of the chute is preferably substantially U-shaped.

In an embodiment of the present invention, the inclination angle of the chute in the front-rear direction and the inclination angle of the chute on the inclined plane with respect to the vertical direction are preferably adjustable.

In an embodiment of the present invention, the chute is preferably arranged facing the vertical direction on the inclined plane arranged in a manner inclined in the front-rear direction, and the cross-section of each longitudinal groove provided in the chute along a direction orthogonal to the longitudinal direction of the chute preferably has an asymmetrical shape in the width direction of the chute.

In an embodiment of the present invention, the cross-section of each longitudinal groove provided in the chute along a direction orthogonal to the longitudinal direction of the chute preferably has a substantially sawtooth shape.

In the present invention, the objects to be sorted with the flat shape are rice grains, and the optical detection unit is preferably capable of detecting bran remaining on back strings of the rice grains at the detection position.

### Advantageous Effects of Invention

With the method for detecting objects to be sorted with the optical sorter according to an embodiment of the present invention, objects to be sorted with a flat shape are allowed to flow downward on the surface of the chute such that substantially flat faces of the objects to be sorted touch the elongated protruding walls in the longitudinal grooves, and lateral portions of the objects to be sorted face the front-rear direction of the chute. Accordingly, the optical detection unit detects the lateral portions of the objects to be sorted at the detection position.

Thus, with the method for detecting objects to be sorted with the optical sorter according to an embodiment of the present invention, it is possible to detect lateral portions of objects to be sorted with a flat shape.

With the method for detecting objects to be sorted with the optical sorter according to an embodiment of the present invention, if the objects to be sorted with the flat shape are rice grains, it is possible to detect bran remaining on back strings of the rice grains.

The optical sorter according to an embodiment of the present invention is configured such that when objects to be sorted with a flat shape flow downward on the surface of the chute, the objects to be sorted are allowed to flow downward on the surface of the chute such that substantially flat faces of the objects to be sorted touch the elongated protruding walls in the longitudinal grooves, and lateral portions of the objects to be sorted face the front-rear direction of the chute. Accordingly, in the optical sorter, the optical detection unit can detect the lateral portions of the objects to be sorted at the detection position.

Therefore, with the optical sorter according to an embodiment of the present invention, it is possible to detect lateral portions of objects to be sorted with a flat shape.

In the optical sorter according to an embodiment of the present invention, the chute is inclined at a predetermined angle with respect to the vertical direction on the inclined plane arranged in a manner inclined in the front-rear direction. Accordingly, the optical sorter can allow objects to be sorted with a flat shape to flow downward on the surface of the chute such that substantially flat faces of the objects to be sorted touch the elongated protruding walls in the longitudinal grooves, and lateral portions of the objects to be sorted face the front-rear direction of the chute.

In the optical sorter according to an embodiment of the present invention, the cross-section of each longitudinal groove provided in the chute along a direction orthogonal to the longitudinal direction of the chute is substantially U-shaped. Accordingly, the optical sorter can allow objects to be sorted with a flat shape to flow downward on the surface of the chute such that substantially flat faces of the objects to be sorted touch the elongated protruding walls forming the substantially U-shaped cross-section in the longitudinal grooves, and lateral portions of the objects to be sorted face the front-rear direction of the chute.

In the optical sorter according to an embodiment of the present invention, the inclination angle of the chute in the front-rear direction and the inclination angle of the chute on the inclined plane with respect to the vertical direction are adjustable. Accordingly, the optical sorter can adjust the flow-down speed of objects to be sorted flowing downward on the surface of the chute, which changes as the inclination angle of the chute on the inclined plane with respect to the vertical direction is changed, by changing the inclination angle of the chute in the front-rear direction.

In the optical sorter according to an embodiment of the present invention, the chute is arranged facing the vertical direction on the inclined plane arranged in a manner inclined in the front-rear direction. In addition, the cross-section of each longitudinal groove provided in the chute along a direction orthogonal to the longitudinal direction of the chute has an asymmetrical shape in the width direction of the chute. Accordingly, the optical sorter can allow objects to be sorted with a flat shape to flow downward on the surface of the chute such that substantially flat faces of the objects to be sorted touch the elongated protruding walls forming the asymmetrical cross-section in the longitudinal grooves, and lateral portions of the objects to be sorted face the front-rear direction of the chute.

In the optical sorter according to an embodiment of the present invention, the cross-section of each longitudinal groove provided in the chute along a direction orthogonal to the longitudinal direction of the chute has a substantially sawtooth shape. Accordingly, the optical sorter can allow objects to be sorted with a flat shape to flow downward on the surface of the chute such chat substantially flat faces of the objects to be sorted touch the elongated protruding walls forming the substantially sawtooth shaped cross-section in the longitudinal grooves, and lateral portions of the objects to be sorted face the front-rear direction of the chute.

With the optical sorter according to an embodiment of the present invention, when the objects to be sorted with the flat shape are rice grains, it is possible to detect bran remaining on back strings of the rice grains.

If the rice grains having bran remaining on their back strings, which have been detected with the optical sorter according to an embodiment of the present invention, are polished again with a rice polishing machine, a reduction in yield can be prevented.

### BRIEF DESCRIPTION OF DRAWINGS

FIG. 1 is a schematic sectional side view of an optical sorter.

FIG. 2 is an explanatory view of optical detection devices.

FIG. 3A is an explanatory view of a rice grain.

FIG. 3B is an explanatory view of a rice grain.

FIG. 3C is an explanatory view of a rice grain.

FIG. 4 is an explanatory view of a chute of Embodiment 1 as seen from the front side.

FIG. 5 is an explanatory view of the chute of Embodiment 1 as seen from a lateral side.

FIG. 6 is an explanatory view of the chute of Embodiment 1 as seen from the lower end side.

FIG. 7 is an explanatory view of rice grains detected at a detection position in Embodiment 1.

FIG. 8 is an explanatory view of a chute of Embodiment 2 as seen from the lower end side.

FIG. 9 is an explanatory view of rice grains detected at a detection position in Embodiment 2.

### DESCRIPTION OF EMBODIMENTS

Embodiments of the present invention will be described with reference to the drawings.

### <Optical Sorter>

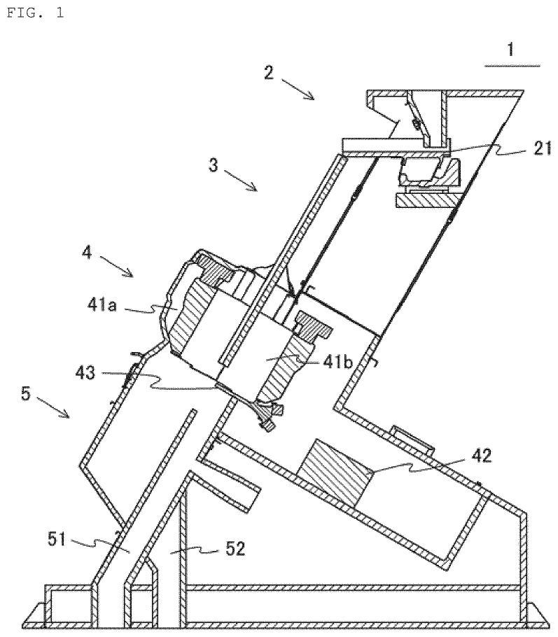

FIG. 1 is a schematic sectional side view illustrating an example of an optical sorter.

An optical sorter 1 illustrated in FIG. 1 includes a granular matter supply unit 2 that supplies granular matters as raw material, a chute 3 that is arranged in an inclined manner and thus allows granular matters to flow downward, an optical sorting unit 4 that detects granular matters falling from the lower end of the chute 3 and sorts the granular matters into non-defective granular matters and defective granular matters based on the results of detection, and a discharge hopper 5 that separately discharges the granular matters sorted into non-defective granular matters and defective granular matters by the optical sorting unit 4.

The granular matter supply unit 2 includes a raw material tank (not illustrated) and a vibrating feeder 21 that supplies granular matters stored in the raw material tank to the chute 3.

The chute 3 has a predetermined width. The chute 3 is arranged at a position below the tip end side of the vibrating feeder 21 in a manner inclined in the front-rear direction with respect to the downward-flow face of the chute 3, and thus allows granular matters fed from the vibrating feeder 21 to flow downward by gravity.

The optical sorting unit 4 includes a pair of optical detection devices 41a and 41b arranged on the front side and the rear side of the fall-down path of granular matters falling from the lower end of the chute 3, a determination device 42 that determines if the granular matters are non-defective granular matters or defective granular matters based on imaging signals obtained with the optical detection devices 41a and 41b, and an ejector device that sorts the granular matters into non-defective granular matters and defective granular matters by removing the defective granular matters based on the results of determination of the determination device 42.

The discharge hopper 5 includes a non-defective-granular matter discharge passage 51 and a defective-granular matter discharge passage 52 that separately discharge the granular matters sorted into non-defective granular matters and defective granular matters by the ejector device.

In the optical sorter 1, granular matters stored in the raw material tank of the granular matter supply unit 2 are continuously fed to the chute 3 by the vibrating feeder 21. The granular matters fed to the chute 3 flow continuously downward by gravity, while spreading in the width direction on the surface of the chute 3, and then fall freely along a predetermined path from the lower end of the chute.

The granular matters falling from the lower end of the chute 3 are imaged by imaging units of the pair of optical detection devices 41a and 41b in the optical sorting unit 4. The determination device 42 compares the optical levels, such as the amounts of light or color components, of the image signals obtained with the imaging units with a threshold. Accordingly, the determination device 42 determines if the granular matters are non-defective granular matters or defective granular matters. The defective granular matters are removed from the predetermined path with air blasted from the elector device based on a removal signal sent from the determination device 42. Consequently, the granular matters are sorted into the non-defective granular matters and the defective granular matters.

Then, the granular matters sorted as the non-defective granular matters are discharged from the non-defective-granular matter discharge passage 51 of the discharge hopper 5, and the granular matters sorted as the defective granular matters are discharged from the defective-granular matter discharge passage 52 of the discharge hopper 5.

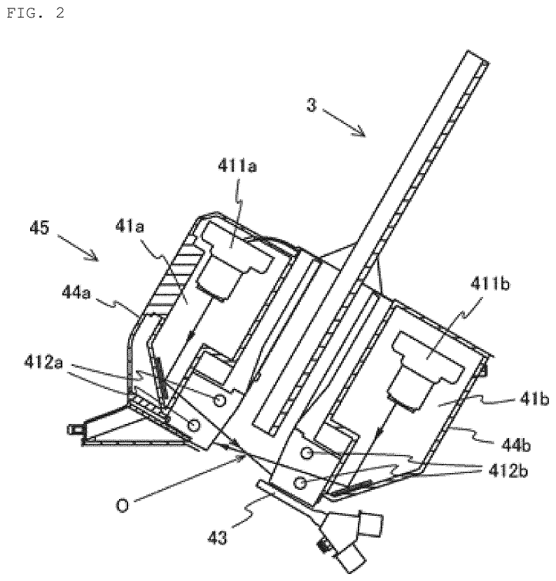

FIG. 2 is an explanatory view of the optical detection devices.

Each of the optical detection devices 41a and 41b incorporates a line sensor or an area sensor, such as a CCD, that can deal with granular matters that fall freely while spreading in the width direction from the lower end of the chute 3. The optical detection devices 41a and 41b respectively include imaging units 411a and 411b, such as CCD cameras, which can receive light in the wavelength range of near infrared rays (NIR), visible rays, or ultraviolet rays, for example, illumination units 412a and 412b, such as LED light sources or fluorescent lamps, that illuminate a detection position O extending linearly in the width direction on the fall-down path of granular matters, and a background portion serving as a background when granular matters are imaged by the imaging units 411a and 411b at the detection position O.

Herein, the pair of optical detection devices 41a and 41b are arranged within a pair of covers 44a and 44b with upper portions openably and closably coupled thereto with hinges, and form a camera unit 45.

In addition, the chute 3 is integrally attachable to the camera unit 45.

The ejector device can deal with granular matters that fall freely while spreading in the width direction from the lower end of the chute 3 as with the optical detection devices 41a and 41b. The ejector device includes an ejector nozzle 43 that can selectively blast air from a plurality of nozzle holes formed therein in the width direction, and an ejector drive device (not illustrated) that allows air to be blasted from the ejector nozzle 43 based on a removal signal sent from the determination device 42.

The ejector nozzle 43 is integrally attachable to the camera unit 45.

### <Rice Grain>

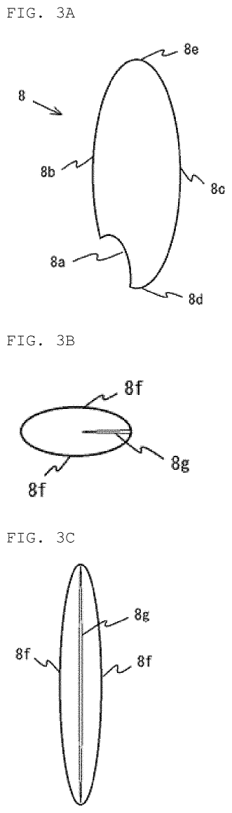

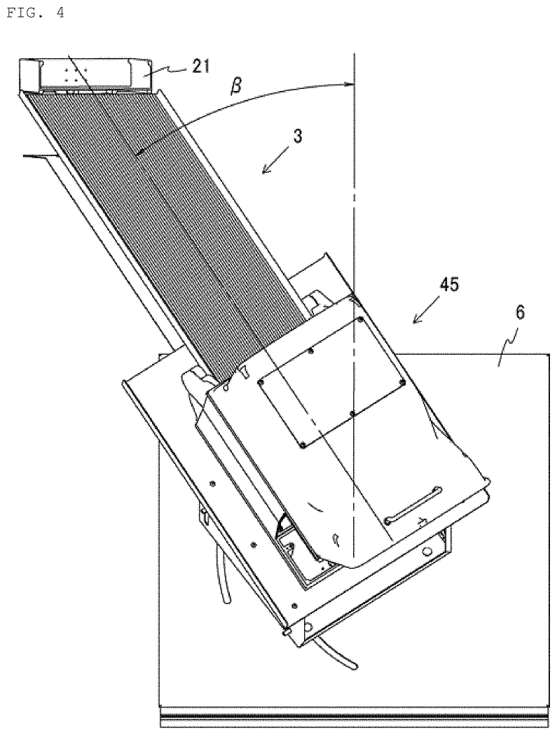

FIGS. 3A to 3C are explanatory views of a rice grain as an example of a granular matter with a flat shape. FIG. 3A is a front view of the rice grain, FIG. 3B is a plan view of the rice grain, and FIG. 3C is a right side view of the rice grain.

In a rice grain 8 of FIG. 3A, the left side including a germ portion 8a is called an abdominal portion 8b, the right side is called a back portion 8c, the lower side is called a base portion 8d, and the upper side is called a head portion 8e. The rice grain 8 has a substantially oval spherical shape such that it is long and thin along the longitudinal direction connecting the base portion 8d and the head portion 8e and is flat along the direction orthogonal to the longitudinal direction. In addition, as illustrated in FIG. 3B, substantially flat faces on the upper side and the lower side of the rice grain 8 are called lateral faces 8f, and a cross-section orthogonal to the longitudinal direction has a flat, substantially oval shape. Further, as illustrated in FIG. 3C, the rice grain 8 has a string-like recess called a back string 8g in the center of the back portion 8c.

The presence of such a back string is prominent in long-grain rice, and it is often the case that bran on the back string cannot be completely removed through rice polishing and thus remains as a bran line (i.e., bran streak) 8h.

### Embodiment 1

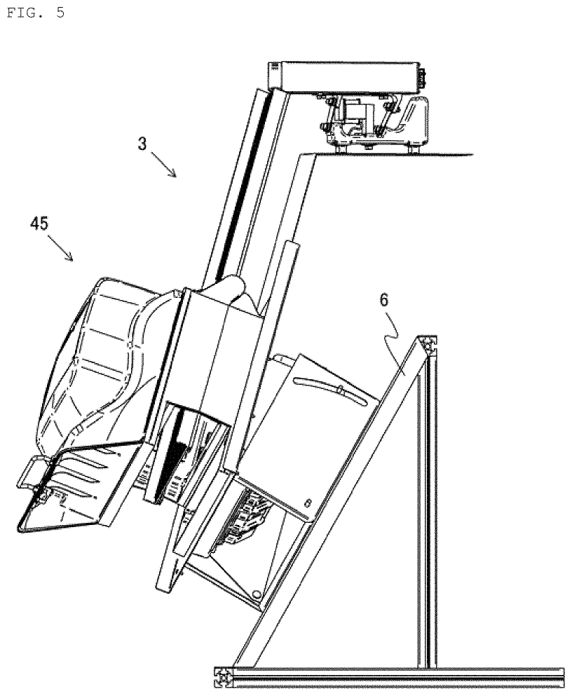

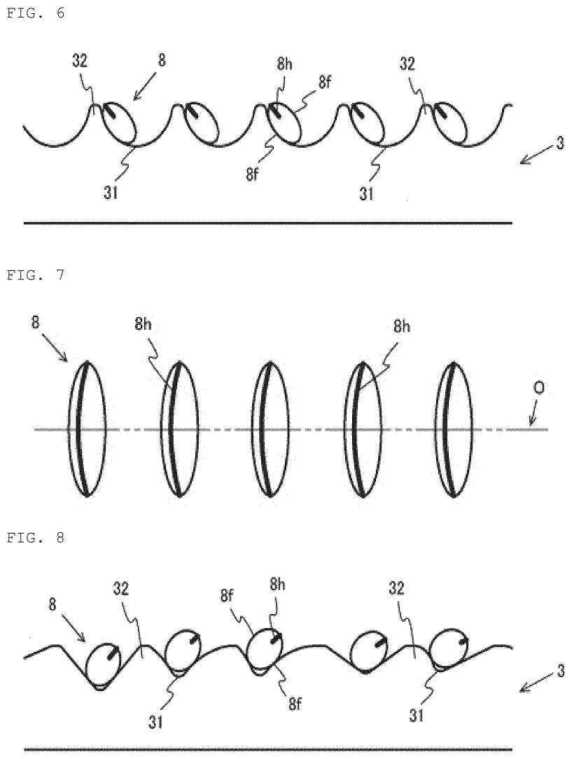

FIG. 4 is an explanatory view of a chute of an optical sorter of Embodiment 1 as seen from the front side. FIG. 5 is an explanatory view of the chute of FIG. 4 as seen from a lateral side. FIG. 6 is an enlarged explanatory view of the chute of FIG. 4 as seen from the lower end side. FIG. 7 is an enlarged explanatory view of rice grains detected at a detection position.

As illustrated in FIGS. 4 and 5, the optical sorter of Embodiment 1 is configured such that the chute 3 is provided in an inclined manner by being rotated by a predetermined angle β (5 to 50 degrees, or preferably, 35 degrees) with respect to the vertical direction orthogonal to the horizontal direction on an inclined plane of an inclined plate 6 arranged in a manner inclined at a predetermined angle, such as 60 degrees in the example illustrated in FIG. 5, in the front-rear direction with respect to the downward-flow face of the chute 3.

In addition, the chute 3 is provided with a plurality parallel longitudinal grooves 31 formed in the longitudinal direction by a plurality of elongated protruding walls 32. In the example illustrated in FIG. 6, each longitudinal groove 31 is formed such that its cross-section orthogonal to the longitudinal direction of the chute 3 is substantially U-shaped.

It should be noted that the basic configuration of the optical sorter of Embodiment 1 is as described with reference to FIGS. 1 and 2. Thus, the description thereof is omitted herein.

In the optical sorter of Embodiment 1, as illustrated in FIG. 6, the rice grains 8 flow downward on the surface of the chute 3 such that the substantially flat lateral faces 8f of the rice grains 8 touch the elongated protruding walls 32 forming the substantially U-shaped cross-section in the longitudinal grooves 31 and the lateral portions (i.e., the abdominal portions 8b and the back portions 8c) of the rice grains 8 face the front-rear direction of the chute 3.

Then, the rice grains 8 to fall from the lower end of the chute 3 fall such that as illustrated in FIG. 7, the lateral portions of the rice grains 8 face the pair of optical detection devices 41a and 41b, which are arranged on the front side and the rear side of the fall-down path of the rice grains 8, at the detection position O extending linearly.

Therefore, according to the optical sorter of Embodiment 1, the sensors of the optical detection devices 41a and 41b can detect the lateral portions of the rice grains 8 at the detection position O. Consequently, the bran lines 8h remaining on the back strings 8g of the rice grains 8 can be detected.

Herein, as illustrated in FIGS. 4 and 5, in the optical sorter of Embodiment 1, the chute 3 is integrally attached to the camera unit 45. The chute 3 is configured such that its inclination angle in the front-rear direction of the chute 3 as well as its inclination angle with respect to the vertical direction is adjustable together with the camera unit 45.

Therefore, according to the optical sorter of Embodiment 1, it is possible to adjust the flow-down speed of rice grains flowing downward on the surface of the chute 3, which changes as the inclination angle β of the chute 3 with respect to the vertical direction is changed, by changing the inclination angle of the chute 3 in the front-rear direction.

Although FIG. 6 illustrates an example in which the cross-section of each longitudinal groove 31 provided in the chute 3 along a direction orthogonal to the longitudinal direction of the chute 3 is substantially U-shaped, the present invention is not limited thereto. The cross-section of each longitudinal groove 31 along the direction orthogonal to the longitudinal direction of the chute 3 may have other shapes as long as the rice grain 8 flows downward on the surface of the chute 3 such that, in the longitudinal groove 31, the substantially flat lateral faces 8f of the rice grain 8 touch the elongated protruding walls 32 forming the longitudinal groove 31, and the lateral portions of the rice grain 8 face the front-rear direction of the chute 3.

In the example illustrated in FIGS. 4 and 5, the upper end of the chute 3 is formed horizontal to allow granular matters to be easily fed to the chute 3 from the vibrating feeder 21, but the upper end of the chute 3 need not necessarily be horizontal and may be orthogonal to the longitudinal direction of the chute 3.

In addition, the lower end of the chute 3 is formed orthogonal to the longitudinal direction of the chute, but it is possible to make the lower end of the chute 3 horizontal by appropriately adjusting the position of the camera unit 45, for example.

### Embodiment 2

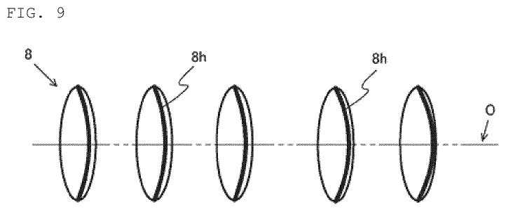

FIG. 8 is an enlarged explanatory view of a chute of an optical sorter of Embodiment 2 as seen from the lower end side. FIG. 9 is an enlarged explanatory view of rice grains detected at a detection position.

The optical sorter of Embodiment 2 has a configuration obtained by, in the optical sorter of Embodiment 1, arranging the chute 3 such that it faces the vertical direction orthogonal to the horizontal direction on the inclined plane of the inclined plate 6 that is arranged in a manner inclined at a predetermined angle in the front-rear direction with respect to the downward-flow face of the chute 3.

In addition, the chute 3 is provided with a plurality of longitudinal grooves 31 formed in the longitudinal direction by a plurality of elongated protruding wails 32. In the example illustrated in FIG. 8, the cross-section of each longitudinal groove 31 along a direction orthogonal to the longitudinal direction of the chute 3 has an asymmetrical shape such that it changes irregularly in the width direction of the chute 3.

It should be noted that the basic configuration of the optical sorter of Embodiment 2 is also as described with reference to FIGS. 1 and 2. Thus, the description thereof is omitted herein.

In the optical sorter of Embodiment 2, as illustrated in FIG. 8, the rice grains 8 flow downward on the surface of the chute 3 such that the substantially flat lateral faces 8f of the rice grains 8 touch the elongated protruding walls 32 forming the asymmetrical cross-section in the longitudinal grooves 31, and the lateral portions (i.e., the abdominal portions 8b and the back portions 8c) of the rice grains 8 face the front-rear direction of the chute 3.

Then, the rice grains 8 to fall from the lower end of the chute 3 fall such that as illustrated in FIG. 9, the lateral portions of the rice grains 8 face the pair of optical detection devices 41a and 41b, which are arranged on the front side and the rear side of the fall-down path of the rice grains 8, at the detection position O extending linearly.

Therefore, according to the optical sorter of Embodiment 2 also, the sensors of the optical detection devices 41a and 41b can detect the lateral portions of the rice grains 8 at the detection position O. Consequently, the bran lines 8h remaining on the back strings 8g of the rice grains 8 can be detected.

Although FIG. 8 illustrates an example in which the cross-section of each longitudinal groove 31 provided in the chute 3 along the direction orthogonal to the longitudinal direction of the chute 3 has an asymmetrical shape such that it changes irregularly in the width direction of the chute 3, the present invention is not limited thereto. The cross-section of each longitudinal groove 31 may have an asymmetrical shape such that it changes regularly in the width direction of the chute 3 like a substantially sawtooth shape, for example, as long as the rice grain 8 flows downward on the surface of the chute 3 such that, in the longitudinal groove 31, the substantially flat lateral faces 8f of the rice grain 8 touch the elongated protruding walls 32 forming the longitudinal groove 31, and the lateral portions of the rice 8 face the front-rear direction of the chute 3.

Although the aforementioned embodiments of the present invention have illustrated rice grains as an example of granular matters, it is also possible to detect lateral portions of other granular matters with a flat shape in a similar manner.

In addition, although granular matters that fall from the lower end of the chute are detected by the optical detection devices 41a and 41b in the aforementioned embodiments of the present invention, it is also possible to detect granular matters that flow downward on the surface of the chute via slits provided in the downward-flow face of the chute in a direction orthogonal to the longitudinal direction of the chute.

Although the embodiments of the present invention have been described above, the present invention is not limited thereto, and the configuration of the present invention can be changed as appropriate within the scope of the invention.

### INDUSTRIAL APPLICABILITY

According to an embodiment of the present invention, it is possible to detect lateral portions of objects to be sorted with a flat shape, in particular, bran lines remaining on back strings if the objects are rice grains. Thus, it is extremely useful.

### REFERENCE SIGNS LIST

1 Optical sorter
2 Granular matter supply unit
21 Vibrating feeder
3 Chute
31 Longitudinal groove
32 Elongated protruding wail
4 Optical sorting unit
41a, 41b Optical detection devices
411a, 411b imaging units
412a, 412b Illumination units
42 Determination device
43 Ejector nozzle
5 Discharge hopper
51 Non-defective-granular matter discharge passage
52 Defective-granular matter discharge passage
6 Inclined plate
8 Rice grain
8a Germ portion
8b Abdominal portion
8c Back portion
8d Base portion
8e Head portion
8f Lateral face
8g Back string
8h Bran line (bran streak)

1. A method for detecting objects to be sorted with an optical sorter that detects lateral portions of objects to be sorted with a flat shape, the optical sorter comprising:
a chute with a predetermined width arranged in a manner inclined in a front-rear direction to allow the objects to be sorted to flow downward,
an optical detection unit that detects the objects to be sorted at a detection position extending linearly, and
an ejector unit that sorts and removes the objects to be sorted based on a result of detection of the optical detection unit,
wherein:
the chute is provided with a plurality of parallel longitudinal grooves formed in a longitudinal direction by a plurality of elongated protruding walls, and
the objects to be sorted with the flat shape are allowed to flow downward on a surface of the chute such that substantially flat faces of the objects to be sorted touch the elongated protruding walls in the longitudinal grooves, and lateral portions of the objects to be sorted face the front-rear direction of the chute so that the optical detection unit detects the lateral portions of the objects to be sorted at the detection position.

2. The method for detecting objects to be sorted with the optical sorter according to claim 1,
wherein:
the objects to be sorted with the flat shape are rice grains, and
the optical detection unit detects bran remaining on back strings of the rice grains at the detection position.

3. An optical sorter comprising:
a chute with a predetermined width arranged in a manner inclined in a front-rear direction to allow objects to be sorted to flow downward;
an optical detection unit that detects the objects to be sorted at a detection position extending linearly; and
an ejector unit that sorts and removes the objects to be sorted based on a result of detection of the optical detection unit,
wherein:
the chute is provided with a plurality of parallel longitudinal grooves formed in a longitudinal direction by a plurality of elongated protruding walls, and
when objects to be sorted with a flat shape flow downward on a surface of the chute, the objects to be sorted are allowed to flow downward on the surface of the chute such that substantially flat faces of the objects to be sorted touch the elongated protruding walls in the longitudinal grooves, and lateral portions of the objects to be sorted face the front-rear direction of the chute so that the optical detection unit can detect the lateral portions of the objects to be sorted at the detection position.

4. The optical sorter according to claim 3, wherein the chute is inclined at a predetermined angle with respect to a vertical direction on an inclined plane arranged in a manner inclined in the front-rear direction.

5. The optical sorter according to claim 4, wherein a cross-section of each longitudinal groove provided in the chute along a direction orthogonal to the longitudinal direction of the chute is substantially U-shaped.

6. The optical sorter according to claim 4, wherein an inclination angle of the chute in the front-rear direction and an inclination angle of the chute on the inclined plane with respect to the vertical direction are adjustable.

7. The optical sorter according to claim 3,
wherein:
the chute is arranged facing a vertical direction on an inclined plane arranged in a manner inclined in the front-rear direction, and
a cross-section of each longitudinal groove provided in the chute along a direction orthogonal to the longitudinal direction of the chute has an asymmetrical shape in a width direction of the chute.

8. The optical sorter according to claim 3,
wherein:
the objects to be sorted with the flat shape are rice grains, and
the optical detection unit detects bran remaining on back strings of the rice grains at the detection position.

9. The optical sorter according to claim 5, wherein an inclination angle of the chute in the front-rear direction and an inclination angle of the chute on the inclined plane with respect to the vertical direction are adjustable.

10. The optical sorter according to claim 4,
wherein:
the objects to be sorted with the flat shape are rice grains, and
the optical detection unit detects bran remaining on back strings of the rice grains at the detection position.

11. The optical sorter according to claim 5,
wherein:
the objects to be sorted with the flat shape are rice grains, and
the optical detection unit detects bran remaining on back strings of the rice grains at the detection position.

12. The optical sorter according to claim 6,
wherein:
the objects to be sorted with the flat shape are rice grains, and
the optical detection unit detects bran remaining on back strings of the rice grains at the detection position.

13. The optical sorter according to claim 7,
wherein:
the objects to be sorted with the flat shape are rice grains, and
the optical detection unit detects bran remaining on back strings of the rice grains at the detection position.
